(19) United States
(12) Patent Application Publication
(10) Pub. No.: US 2012/0103538 A1
(43) Pub. Date: May 3, 2012

(54) Window Treatment Assemblies

(76) Inventor: Herbert Gleinser, Jacksonville, FL (US)

(21) Appl. No.: 13/280,636

(22) Filed: Oct. 25, 2011

Related U.S. Application Data
(60) Provisional application No. 61/455,880, filed on Oct. 28, 2010.
(60) Provisional application No. 61/461,498, filed on Jan. 19, 2011.
(60) Provisional application No. 61/516,809, filed on Apr. 8, 2011.

(51) Int. Cl. E06B 9/262; E06B 9/06

(52) U.S. Cl. 160/84.04; 160/89

(57) ABSTRACT

A window treatment assembly that results in a plurality of horizontal folds when raised, the assembly having a decorative panel member, a liner panel member attached to the decorative panel member, a plurality of loop guide members positioned in horizontal rows on the front side of the liner panel member, horizontal slat members received by the loop guide members, a plurality of vertically oriented, substantially stiff, lifting band members passing freely between the slat members and the liner panel member, the band members being attached at or adjacent the lowermost row of the loop guide members, such that when the band members are retracted in the vertical direction, the decorative panel member and liner panel member are raised.

This application claims the benefit of U.S. Provisional Patent Application Ser. No. 61/455,880, filed Oct. 28, 2010, U.S. Provisional Patent Application Ser. No. 61/461,498, filed Jan. 19, 2011, and U.S. Provisional Patent Application Ser. No. 61/516,809, filed Apr. 8, 2011, the disclosures of which are incorporated herein by reference.

### BACKGROUND OF THE INVENTION

The invention relates most broadly to window treatment assemblies, a collective term for shades, blinds, decorative fabric covers and the like that are used in connection with windows or glass walls, and more particularly relates to window treatment assemblies that are raised and lowered to expose or block the window or wall, as opposed to being opened and closed laterally. Even more particularly, the invention relates to such window treatments wherein the gathering of the window treatment sheet panel member or members results in a grouping of generally horizontal folds or pleats as the panel members are raised.

It is well known to provide window treatment assemblies with a plurality of vertically oriented pull cords that pass through vertically aligned rings or similar guide structure elements. The guide structures are horizontally aligned at fold lines on the window treatment panels. The window treatment may comprise a single face panel of decorative fabric or the like, or may comprise a liner panel coextensively or intermittently attached to the decorative fabric face panel member. The decorative face panel member may present a flat, pleated or folded front when in the extended position. The pull cords are connected to the lowermost fold line at or near the top of the bottom flap of the panel member or members, but are free to pass or slide vertically through the guide structures in either direction. When the pull cords are fully extended, the window treatment panels are in the fully extended position covering the window. By retrieving the pull cords in the upward direction, the bottom flap of the window treatment is advanced upward to expose the window. As each successive horizontal row of guide structures is reached, folds are created in the window treatment panel members. Releasing or extending the pull cords downward results in an unfolding and extension of the window treatment panels.

An embodiment of these types of window treatment assemblies is shown in U.S. Pat. No. 5,662,147, the disclosure of which is incorporated by reference herein, wherein the guide structures comprise sets of aligned threads, preferably formed in a liner sheet or panel member, that extend from the surface of the liner sheet member in groups to form loops. The loops are created during the weaving process of a liner fabric panel by not interweaving over a short distance the loop threads with the perpendicular threads forming the sheet member. Utilizing loops that are formed as part of a fabric panel to guide the pull cords is preferred since the use of rigid structural members such as rings or slats creates a bulkiness which is not aesthetically pleasing, and also requires additional manufacturing and assembly steps in the creation of the window treatment.

There has been heightened concern over the safety of window treatments that utilize pull cords due to the chance that young children can become entangled in the pull cords and suffocate. Because such unfortunate incidents have occurred, various governmental regulations have been enacted to minimize or alleviate the danger. In the type of window treatment assemblies described above, regulations require that the pull cords not be able to be pulled laterally from the window treatment assembly into the form of a loop having a circumference greater than 16 inches, and the pull cords must also be formed so as to break under a five pound load.

It is an object of this invention to provide window treatment assemblies of this type that address the described problems. The window treatments utilize substantially stiff bands, tapes or strip members to raise and lower the panel members, the bands having sufficient width and stiffness such that they cannot be pulled laterally into a looped configuration when assembled as part of the window treatment assembly.

### SUMMARY OF THE INVENTION

The invention in certain embodiments comprises in general a window treatment assembly comprising a decorative sheet or panel member which can be raised and lower to expose or cover the window, wherein when raised the window treatment panel member is reoriented from a generally flat, suspended configuration that covers the entire window into a configuration with a plurality of horizontal folds or pleats, thereby exposing the window. The window treatment assembly comprises an exposed or outer decorative sheet or panel member having a front side and a back side, a liner sheet or panel member having a front side and a back side, the front side of the liner panel member being attached at various points to the back side of the decorative panel member, a plurality of non-rigid, flexible, vertically oriented, loop guide members positioned in horizontal and vertical rows on the front side of the liner panel member, a plurality of horizontally disposed slat members passing through the loop guide members, a plurality of vertically oriented, substantially stiff, lifting band members passing between the liner panel member and the slat members, the band members being attached to the decorative panel member and liner panel member at or adjacent the location of the lowermost slat member, and means to retract and extend the band members in the vertical direction, whereby the decorative panel member and liner panel member are raised and lowered by respectively retracting or extending the band members. Most preferably, the loop members each comprise a plurality of aligned thread members extending from the liner panel member that are not interwoven with the perpendicular thread members over a short distance during manufacture of the liner panel member.

The liner panel member and the decorative panel member are most preferably fabric members, and are joined to each other along horizontal fold lines corresponding or adjacent to the horizontal rows of loop guide members. The decorative panel member may comprise a greater amount of fabric than the liner panel member, such that even in the extended position the decorative panel member will present folds or pleats. The lower ends of the band members are affixed to the decorative and liner panel members at or adjacent the lowermost fold line. When the band members are retracted, the band members slide upward relative to the liner panel member and the decorative panel member and liner panel member are raised together such that they fold horizontally into a configuration of horizontal pleats or folds, thereby exposing the window. The decorative panel member will fold outwardly to the front and the liner panel member will fold outwardly to the rear when the assembly is raised.

The band members are stiff elongated members that are easily rolled about an axis perpendicular to the elongated direction or length, but which resist or restrict movement in the lateral direction (i.e., the direction perpendicular to the elongation direction or length), and in particular resist or restrict such movement within the plane containing the elongated band member.

### BRIEF DESCRIPTION OF THE DRAWINGS

FIG. 1 is a rear view, partially exposed, of a basic embodiment of the window treatment assembly, shown in the fully extended configuration.

Figure is a rear view, partially exposed, of the embodiment of the window treatment assembly of FIG. 1, shown in the partially retracted configuration.

FIG. 3 is a partial cross-sectional view taken along line 3-3 of FIG. 2.

FIG. 4 is a partial view of the front side of the liner panel member, showing the band members extending through the loop guide members.

FIG. 5 is a front view, partially exposed, of a preferred embodiment of the window treatment assembly, shown in the fully extended configuration.

FIG. 6 is a front view, partially exposed, of the embodiment of the window treatment assembly of FIG. 5, shown in the partially retracted configuration.

FIG. 7 is a partial view of the liner panel member of the preferred embodiment of the window treatment assembly of FIG. 5, showing the loop guide members comprising portions of the threads of the liner panel member.

### DETAILED DESCRIPTION OF THE INVENTION

With reference to the drawings, the invention will now be described in detail with regard for the best mode and the preferred embodiment or embodiments. The invention comprises in general a window treatment assembly, such as a decorative fabric curtain, which can be raised and lowered to expose or cover the window, wherein when raised the window treatment fabric reorients itself from a generally flat, suspended configuration covering the window into a configuration having a plurality of horizontal folds or pleats and exposing the window. In the disclosure to follow, the front or face shall reference the exposed side of the window treatment facing away from the window, while the rear or back shall reference the side of the window treatment assembly facing toward the window.

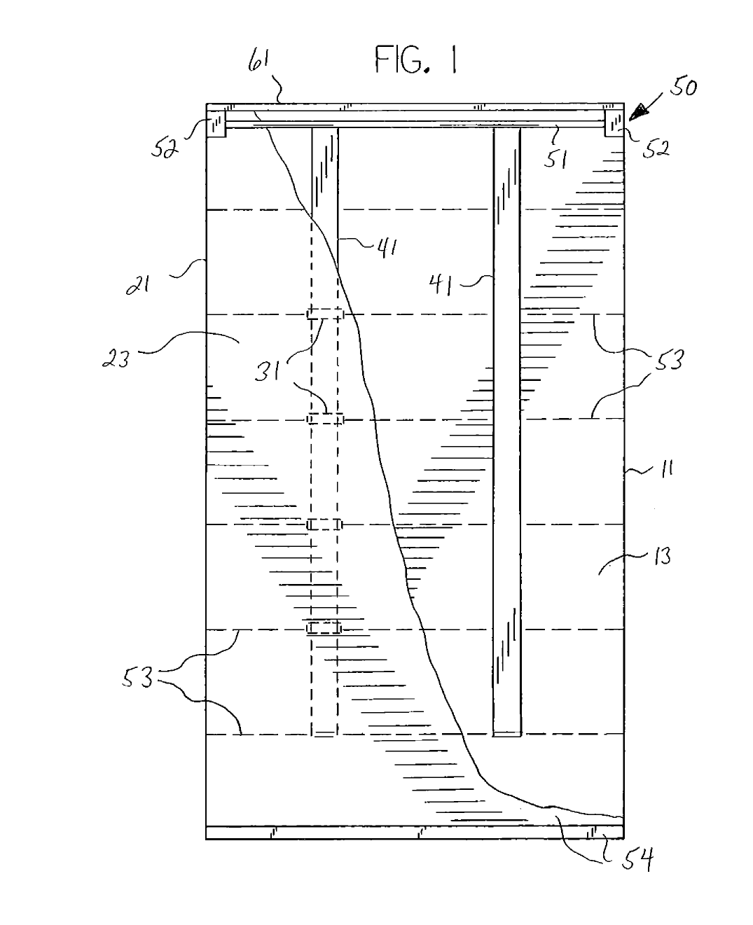

In the basic embodiment shown in FIGS. 1-4, the window treatment assembly comprises an exposed or outer decorative sheet panel member 11 having a front side 12 and a back side 13, a liner sheet or panel member 21 having a front side 22 and a back side 23, the front side 22 of the liner panel member 21 being attached to the back side 13 of the decorative panel member 11, a plurality of flexible, preferably fabric, loop guide members 31 positioned on the front side 22 of the liner panel member 21, a plurality of vertically oriented, stiff, flexible lifting strip or band members 41 passing freely through the loop guide members 31, the band members 41 being attached at the top of the bottom portion 54 of the decorative panel member 11 and liner panel member 21 at positions at or adjacent the lowermost fold line 53, and a retraction mechanism 50 that is capable of retracting and extending the band members 41 in the vertical direction, whereby the bottom flap 54 of the decorative panel member 11 and liner panel member 21 can be raised and lowered by respectively retracting or extending the band members 41.

The liner panel member 21 and the decorative panel member 11 are most preferably fabric members, i.e., formed from interwoven perpendicular threads, but may comprise other sheet materials. The liner panel member 21 and the decorative panel member 11 are joined to each other along horizontal fold joints or lines 53 corresponding or adjacent to the horizontal rows of loop guide members 31, such as with bonding tape, stitching or other known mechanisms. The front side 12 of the decorative panel member 11 will typically comprise a color or pattern that is aesthetically pleasing. The decorative panel member 12 may be relatively flat or may be configured in known manner with permanent horizontal folded portions to create a three dimensional look. The back side 23 of the liner panel member 21 may also be colored or provided with a pattern, but will typically comprise a white or neutral color. The liner panel member 21 may also be composed of an opaque material which serves as a blackout member to preclude the passage of any light through the window treatment.

The horizontal fold joints 53 are preferably formed using adhesive or heat bonding, but may also be created with stitching, mechanical fastening or the like. The loop guide members 31 shown in this embodiment may be attached to the front of the liner panel member 21 by stitching, bonding, adhesive, mechanical fastening or the like, and are disposed in horizontal rows with the loop guide members 31 of each row aligned vertically with the other rows. The front of the loop guide members 31 may also be bonded or otherwise attached to the back side 13 of the decorative panel member 11, but preferably the loop guide members 31 are not directly attached to the back side 13 of the decorative panel member 11. The liner panel member 21 and the decorative panel member 11 are joined on their lower ends to define a bottom flap 54, using adhesives, heat bonding, stitching, mechanical fasteners or the like. Weights and/or a stiffening member to maintain the linear configuration of the bottom portion 54 may be included, or the bottom portion 54 may be less structured such that it may bend and drape. The liner panel member 21 and the decorative panel member 11 are joined at or near their top or upper ends and attached to a mounting member 61 in known manner.

When the band members 41 are retracted, the band members 41 slide through the loop guide members 31 such that the lowermost fold line 53 and the bottom flap 54 of the decorative panel member 11 and liner panel member 21 are raised, with the fold lines 53 contacting each other in succession as the band members 41 are further retracted. In this manner the decorative panel member 11 will fold horizontally along fold joints 53 into a configuration of horizontal pleats or folds 42 extending to the front of the window treatment, while the liner panel member 21 will fold horizontally along fold joints 53 toward the rear. The band members 41 are thin but wide members having a substantially greater width than cords or strings, such as for example about three inches. The loop guide members 31 may be of relatively small dimension in the vertical direction, but must be sufficiently wide such that the band members 41 can freely slide through, such as for example at least about three and one half inches for band members 41 having a width of about three inches.

The band members 41 are stiff elongated members that are easily rolled about an axis perpendicular to their elongated direction or length, but which resist or restrict movement in the lateral direction (i.e., the direction perpendicular to their elongation direction or length), and in particular resist or restrict such movement within the plane containing the elongated band member 41. Preferably, the band members 41 are constructed from thermoset or thermoplastic materials, such that the band members 41 may be heat treated to set or stiffen the material, thereby stiffening the band members 41 such that the construct is much stiffer than a woven fabric member formed of conventional thread material. The band members 41 are constructed to meet required guidelines, such that the band members 41 when assembled in the window treatment assembly between the liner panel member 21 and the decorative panel member 11, and further restricted by the loop guide members 31, cannot be pulled laterally from the window treatment assembly into the form of a loop having a circumference greater than 16 inches.

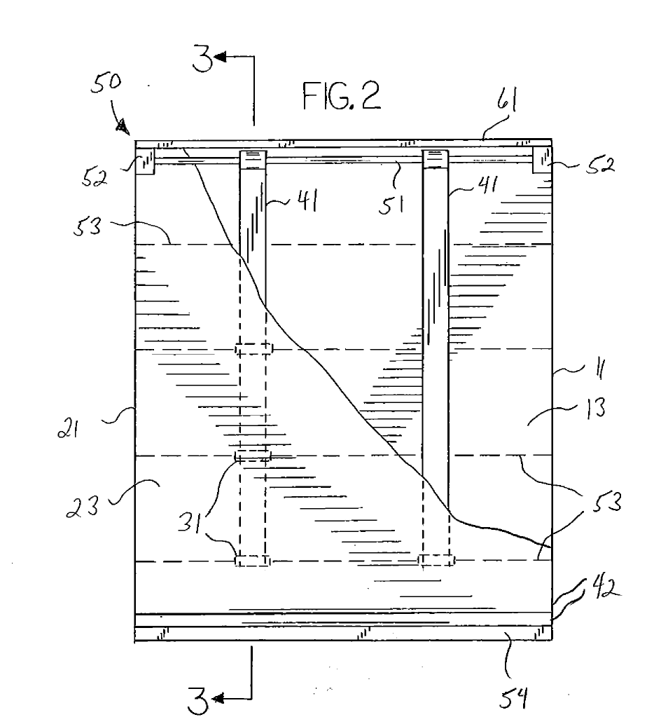

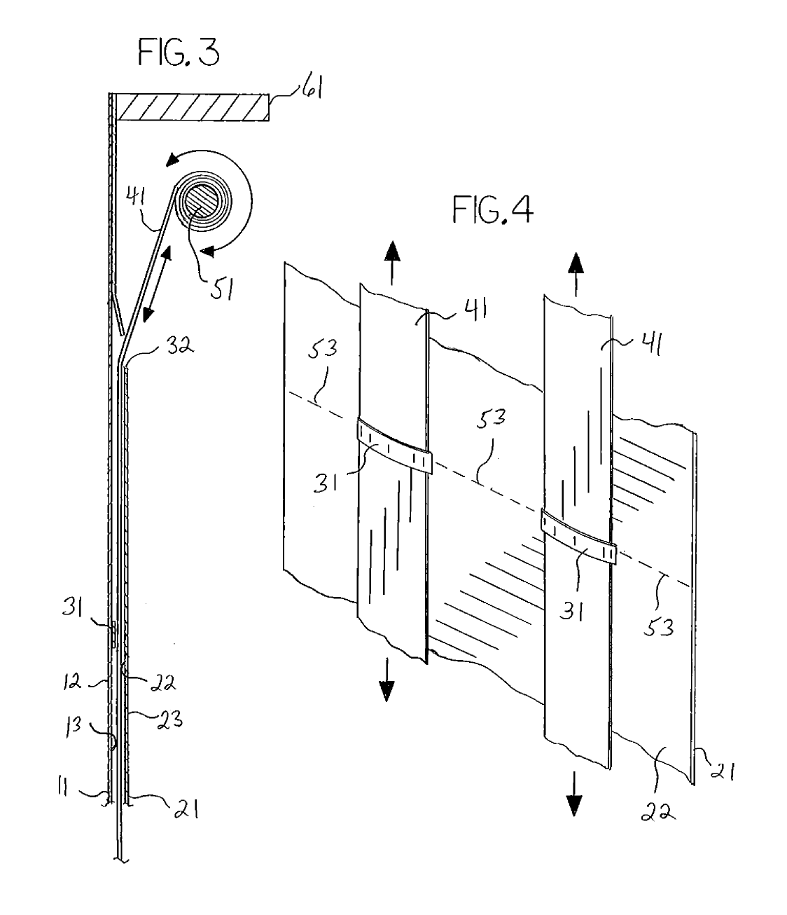

The retraction mechanism 50 capable of retracting and extending the band members 41 preferably comprises a rotating rod member 51 retained by a pair of rod support members 52. The top ends of the band members 41 are secured to the rotating rod member 51, and preferably are secured using spool members having lateral flanges to prevent lateral movement of the band member 41 during winding. To retract or extend the band members 41 in order to raise or lower the bottom 54 of the window treatment, the rod member 51 is rotated either manually or by powered means such that the band members 41 are wound onto or unwound from the rod member 51, as shown in FIG. 3. In this manner, the band members 41 may slide through the loop guide members 31 in the vertical direction, as shown in FIG. 4.

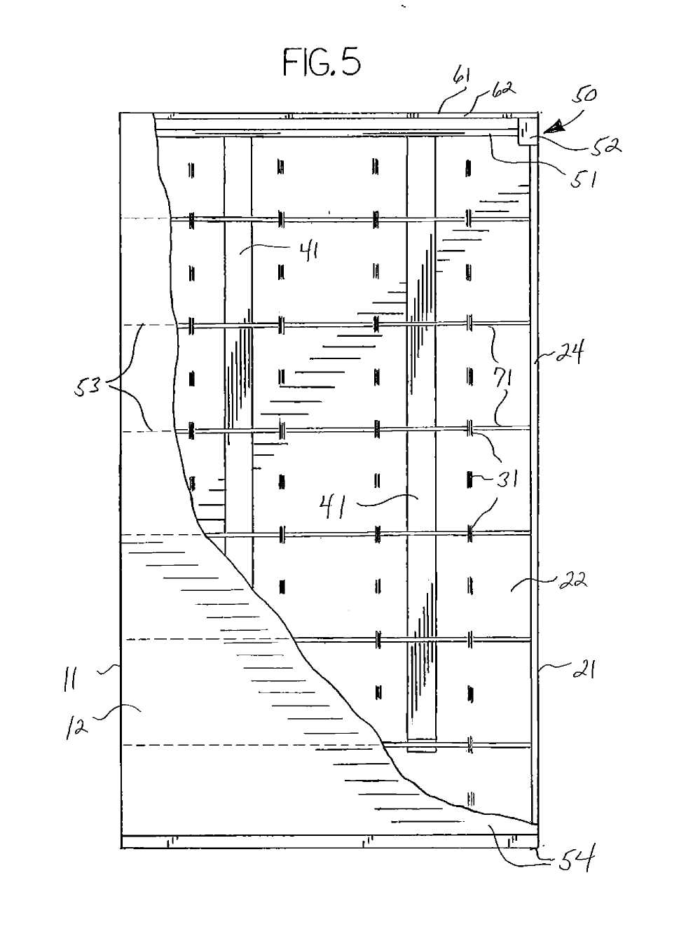

A preferred embodiment of the window treatment assembly is shown in FIGS. 5-7. While the loop guide members 31 may comprise discrete or separate fabric or similarly flexible members attached to the liner panel member 21 through bonding, adhesives, stitching or the like, it is most preferred that the loop guide members 31 comprise an integral part of the material of composition of the liner panel member 21 formed in the weaving process by allowing a plurality of parallel threads to intermittently float across and above the surface of the fabric. This structure is obtained by having short portions of parallel threads that are not interwoven in the usual manner with the threads running perpendicular to the loop-forming threads, as shown in FIG. 7. For example, a small set of alternating weft threads is not woven in normal intersecting manner with the warp threads of the liner panel member 21 over a short distance. The length of the floating weft thread sections determines the width of the loop guide members 31. The loop guide members 31 extend from the front side 22 of the liner panel member 21, i.e., the side which is disposed internally in the assembly, and are oriented vertically rather than horizontally in the assembly in this embodiment. On the back side 23 of the liner panel member 21 the warp and remaining weft threads continue in normal woven manner under the set of floating weft threads to avoid creation of a hole. The loop guide members 31 are aligned in horizontal rows and in vertical columns so as to form a grid pattern of attachment points. In this embodiment, the loop guide members 31 of each horizontal row receive and retain a horizontally-disposed, relatively rigid rod or thin-in-cross-section slat member 71. For example, slat member 71 may be composed of fiberglass. In combination, the loop guide members 31 and the slat members 71 control and retain the band members 41. The band members 41 are disposed between the liner panel member 21 and the slat members 71, and pairs of the loop guide members 31 limit lateral movement of the band members 41. Preferably, each side of the liner panel member 21 is provided with a lateral hem 24 which receives the ends of the slat members 71 so as to prevent horizontal movement of the slat members 71 within the assembly. The locations of the slat members 71 determine the fold lines or joints 53 in this embodiment. Preferably, the liner panel member 21 and the decorative panel member 11 are bonded or otherwise joined together in horizontal strips at locations corresponding to the slat members 71, being either at or adjacent the slat members 71. Bonding may be accomplished for example by using thermal bonding tapes, applied bondable substances, adhesives or the like.

The separation distance between loop guide members 31 within a given horizontal row, as well as the vertical separation distance between rows of loop guide members 31, is variable due to various factors, such as the width of the band members 41, the size of the panel members 11 and 21, the desired number of fold lines 53 when the panel members 11 and 21 are raised, the particular material chosen to form the panel members 11 and 21, etc. In the preferred embodiment as shown, the liner panel member 21 is produced with a large number of horizontal rows of loop guide members 31 which may not all be utilized in a given window treatment assembly. In this manner, a universal liner panel member 21 can be manufactured which is adaptable to many different configurations. The vertical columns define pairs of loop guide members 31 that are relatively closely spaced together, as the purpose of the paired loop guide members 31 is to preclude excessive lateral movement of the band member 41 situated within the pair. Thus, for a band member 41 three inches in width, for example, the pairs of loop guide members 31 may be as little as three and a quarter inches in separation distance.

In this embodiment, the band members 41 are connected to the rotating rod member 51, preferably on spool members having lateral flanges such that spiraling of the band members 41 will not occur during the winding operation. The lower ends of the band members 41 are connected to the decorative panel member 11, either directly or indirectly, at or adjacent the lowermost fold line 53, such as by connecting the band members 41 to the decorative panel member 11, the liner panel member 21, bonding the band member 41 in the fold line 53, securing the band member 41 to the lowermost slat member 71, etc. Thus, the band members 41 move freely in the vertical direction relative to the upper slat members 41, the upper slat members 41 being defined herein as to not include the lowermost slat member 41

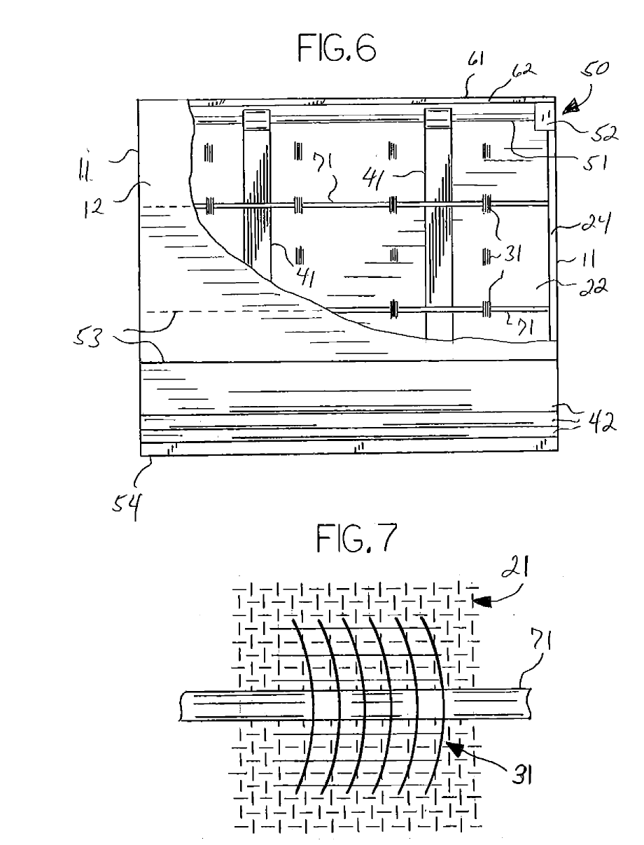

As illustrated in FIGS. 5 and 6, the liner panel member 21 and the decorative panel member 11 may not be joined along the top edge. Instead, the top edge of the decorative panel member 11 is affixed to the front of the mounting member 61 while the top edge of the liner panel member 21 is affixed to the rear of the mounting member 61, preferably in a removable manner such as with a hook-and-loop fastener 62. With this assembly, the retraction mechanism 50 is hidden but accessible for adjustment if needed by temporarily removing the liner panel member 21 from the mounting member 61.

With the embodiments as described, the window treatment assembly is a highly efficient assembly that is streamlined due to the lack of mechanical fasteners and the like which can add bulk to the assembly and reduce the smoothness of the assembly when in use. In addition, the assembly meets and exceeds the safety standards with regard for strangulation endangerment, since the lifting band members 41 are fully enveloped by the liner panel member 21 and the decorative panel member 11, and cannot be pulled laterally from between the decorative panel member 11 and the liner panel member 21. Finally, with the preferred embodiment, assembly is made more efficient since the loop guide members 31 are formed as components of the liner panel member 21 during manufacture and do not need to be attached to the liner panel member 21 in a separate assembly step.

It is understood that equivalents and substitutions for certain elements and structures described above may be obvious to those of ordinary skill in the art, and therefore the true scope and definition of the invention is to be as set forth in the following claims.

I claim:

1. A window treatment assembly comprising:
a decorative panel member;
a liner panel member joined to said decorative panel member;
a retracting mechanism comprising a rotating rod member, whereby said decorative panel member and said liner panel member are raised and lowered by rotation of said rotating rod member;
flexible loop guide members disposed on said liner panel member in horizontal rows and vertical columns;
slat members received within at least some of said loop guide members, said slat members extending horizontally across said liner panel member;
band members connected to said rotating rod member and to said decorative panel at or adjacent the lowermost of said slat members, each said band member being vertically oriented and positioned between said slat members and said liner panel member, and each said band member being positioned between a pair of said loop guide members, wherein said band members move freely in the vertical direction relative to said upper slat members;
whereby upon rotation of said rotating rod member, said band members are wound onto said rotating rod member and said decorative panel member is raised, said decorative panel member and said liner panel member folding at the locations of said slat members.

2. The assembly of claim 1, wherein said decorative panel member and said liner panel member are joined together to form horizontal fold lines.

3. The assembly of claim 2, wherein said fold lines correspond to the locations of said slat members.

4. The assembly of claim 1, wherein said band members are connected to said lowermost slat member.

5. The assembly of claim 1, wherein said liner panel member has a front side and said loop guide members extend from said front side.

6. The assembly of claim 1, wherein said liner panel member has lateral hems and said slat members are retained within said lateral hems.

7. The assembly of claim 1, further comprising a mounting member, wherein said decorative panel member and said liner panel member are connected to said mounting member.

8. The assembly of claim 7, wherein said mounting member has a front and a rear, and wherein said decorative panel member is connected to said front of said mounting member and said liner panel member is removably connected to said rear of said mounting member.

9. The assembly of claim 1, wherein the number of slat members is less than the number of said horizontal rows of said loop guide members.

10. The assembly of claim 1, wherein each of said loop guide members comprises a set of parallel threads of said liner panel member that are not interwoven with perpendicular threads of said liner panel member over a short distance.

11. The assembly of claim 10, wherein said loop guide members are comprised of alternating parallel threads.

12. A window treatment assembly comprising:
a decorative panel member having a top;
a liner panel member composed of interwoven threads and having a top, wherein said liner member and said decorative panel member are intermittently joined together;
a retracting mechanism comprising a rotating rod member whereby said decorative panel member and said liner panel member can be raised and lowered by rotation of said rotating rod member;
loop guide members disposed on said liner panel member in horizontal rows and in vertical columns and extending toward said decorative panel member, each of said loop guide members comprising a set of vertically oriented parallel threads of said liner panel member that are not interwoven with perpendicular threads of said liner panel member over a short distance;
slat members received within at least some of said loop guide members, said slat members extending horizontally across said liner panel member, said slat members comprising a lowermost slat member and upper slat members;
wherein said decorative panel member and said liner panel member are joined together to form horizontal fold lines at locations corresponding to the locations of said slat members;
band members connected to said rotating rod member and to said decorative panel member at or adjacent the lowermost of said fold lines, each said band member being vertically oriented and positioned between at least said upper slat members and said liner panel member, and each said band member being positioned between a horizontal pair of said loop guide members, wherein said band members move freely in the vertical direction relative to said upper slat members;
whereby upon rotation of said rotating rod member, said band members are wound onto said rotating rod member and said decorative panel member and said liner panel member are raised, said decorative panel member and said liner panel member folding at the locations of said slat members.

13. The assembly of claim 12, wherein loop guide members are comprised of alternating parallel threads.

14. The assembly of claim 12, wherein said liner panel member has lateral hems and said slat members are further retained within said lateral hems.

15. The assembly of claim 12, further comprising a mounting member, wherein said decorative panel member and said liner panel member are connected to said mounting member.

16. The assembly of claim 15, wherein said mounting member has a front and a rear, and wherein said decorative panel member is connected to said front of said mounting member and said liner panel member is removably connected to said rear of said mounting member.

17. The assembly of claim 12, wherein said band members are approximately three inches in width.

18. The assembly of claim 12, wherein said band members comprise thermoset or thermoplastic material.

19. The assembly of claim 12, wherein said band members are characterized as being easily rolled about an axis perpendicular to their elongated direction or length, but which resist or restrict movement in the lateral direction.

20. The assembly of claim 12, wherein said band members cannot be pulled laterally from between said decorative panel member and said liner panel member into the form of a loop having a circumference greater than 16 inches.
